(19) United States
(12) Patent Application Publication
(10) Pub. No.: US 2006/0023901 A1
(43) Pub. Date: Feb. 2, 2006

(54) Method and system for online dynamic mixing of digital audio data

(76) Inventors: Ronald Paul Schott, Austin, TX (US); Kelly Patrick Grizzle, Austin, TX (US); Freddy Eugene Williams JR., Austin, TX (US); James Gregory Hughes, Austin, TX (US)

Correspondence Address: Ronald P. Schott, 2617 Gate Ridge Drive, Austin, TX, 78748, US

(21) Appl. No.: 11/193,971

(22) Filed: Jul. 29, 2005

Related U.S. Application Data
(60) Provisional application No. 60/592,795, filed on Jul. 30, 2004.

(51) Int. Cl. H04B 1/00

(52) U.S. Cl. 381/119

(57) ABSTRACT

A system and method are provided for dynamic mixing of digital audio data. The system includes a storage interface to a digital storage. The digital storage maintains at least one general audio track file and at least one personalized audio track file. The system further includes a user interface engine. The user interface engine provides an interface to a user that allows the user to make a selection of the at least one general audio track file. The system further includes a mixing engine. The mixing engine associates the personalized audio track file with the user, retrieves the selected general audio track file and the personalized audio track file, and mixes the selected general audio track file and the personalized audio track file into a final audio track file.

### CROSS-REFERENCE TO RELATED APPLICATION

This application claims the benefit of U.S. Provisional Application No. 60/592795, filed Jul. 30, 2004, entitled Dynamic Online Digital Audio Merge and Mix.

### FIELD OF THE INVENTION

This invention relates in general to the field of communications systems. More particularly, the invention relates to a method and system for dynamic mixing of digital audio data.

### BACKGROUND OF THE INVENTION

“On hold” messages are messages conveyed through a telephone system to customers of a business. For example, when a customer dials by telephone into a business, that customer may be put “on hold.” While on hold, the business can convey information to that customer about the business through a recorded message. Many business owners desire to provide a personalized message to its customers while the customers are on hold. For example, a personalized message may contain the name of the business or business owner while describing the information conveyed to its customers.

Conventional approaches for creating personalized message recordings include several disadvantages. For example, the creation of such a message often requires the use of a professional message recording service. Such a service will collect details about a desired message, assemble and record the message in a recording studio, and present the recorded message as a completed product to the customer thereafter. Such a process is both time-consuming and costly. In addition, there is little flexibility on the part of the business owner if the need arises to modify or adjust the message. Further limitations and disadvantages of conventional solutions will become apparent to one of ordinary skill in the art after reviewing the remainder of the present application with reference to the drawings and detailed description which follow.

### SUMMARY OF THE INVENTION

In accordance with one or more embodiments of the present invention, a system and method are provided for dynamic mixing of digital audio data. The system includes a storage interface to a digital storage. The digital storage maintains at least one general audio track file and at least one personalized audio track file. The system further includes a user interface engine. The user interface engine provides an interface to a user that allows the user to make a selection of the at least one general audio track file. The system further includes a mixing engine. The mixing engine associates the personalized audio track file with the user, retrieves the selected general audio track file and the personalized audio track file, and mixes the selected general audio track file and the personalized audio track file into a final audio track file.

The provided method includes maintaining at least one general audio track file and at least one personalized audio track file. An interface is provided to a user for allowing the user to select a selected general audio track file. The personalized audio track file is associated with the user; the selected general audio track file and the personalized audio track file are retrieved and mixed into a final audio track file.

It is a technical advantage of the present invention that it reduces the cost of and time to create personalized “on hold” messages. Furthermore, the present invention allows for more flexible management of such messages.

It is a further technical advantage of the present invention that the final audio track file can then be provided to the user in various ways. For example, the final audio track file can be downloaded via the internet.

The objects, advantages and other novel features of the present invention will be apparent from the following detailed description when read in conjunction with the attached drawings.

### BRIEF DESCRIPTION OF THE FIGURES

A more complete understanding of the present invention and advantages thereof may be acquired by referring to the following description taken in conjunction with the accompanying drawings in which like reference numbers indicate like features and wherein:

FIG. 1 is a block diagram of a network that includes a dynamic mixing system in accordance with an illustrative embodiment of the present invention;

FIG. 2 is a flow chart of the operation of a dynamic mixing system according to an illustrative embodiment of the present invention;

FIG. 3 illustrates a diagram of a user interaction according to an illustrative embodiment of the present invention;

FIG. 4 illustrates part 1 of 2 of a flow chart of operation of a mixing engine according to an illustrative embodiment of the present invention;

FIG. 5 illustrates part 2 of 2 of a flow chart of operation of a mixing engine according to an illustrative embodiment of the present invention;

FIG. 6 is a flow chart of the operation of a dynamic mixing system according to an illustrative embodiment of the present invention;

FIG. 7 is a flow chart of a session history process according to an illustrative embodiment of the present invention;

FIG. 8 is a flow chart of a custom session process according to an illustrative embodiment of the present invention;

FIG. 9 is a flow chart of a login process according to an illustrative embodiment of the present invention;

FIG. 10 is a flowchart of an account creation process according to an illustrative embodiment of the present invention;

FIG. 11 is a flowchart of an account edit process according to an illustrative embodiment of the present invention;

FIG. 12 is a flowchart of a forgotten password process according to an illustrative embodiment of the present invention; and

FIG. 13 is a flowchart of a process for creating and distributing a bulk message according to an illustrative embodiment of the present invention.

### DETAILED DESCRIPTION OF THE INVENTION

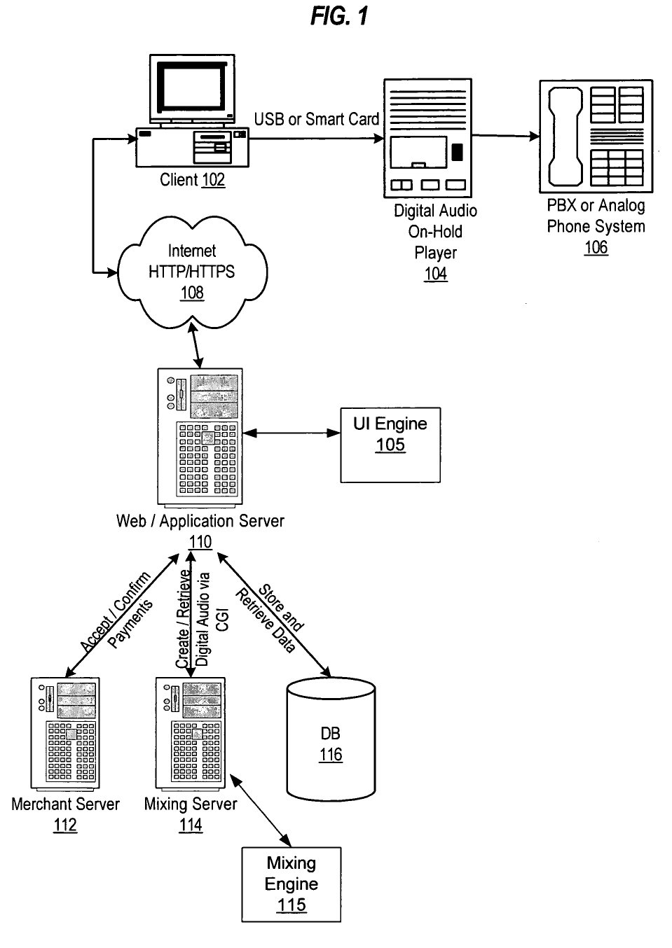

In accordance with one or more illustrative embodiments of the present invention described herein and illustrated in FIGS. 1-13, a method and system are provided for creating customized recorded messages (such as on-hold messages or announcements) having customer-specified features formed by merging, mixing, and distributing voice and music recordings using a communication network interface under control of the customer. For example, FIG. 1 is a block diagram of a network that includes a dynamic mixing system in accordance with an illustrative embodiment of the present invention. In FIG. 1, client 102 includes a device operable to execute software in order to access a communication network. For example, client 102 may include a personal computer executing a web-browser program in order to access the internet. Client 102 is communicatively coupled to digital audio on-hold player 104. Digital audio on-hold player 104 can include a device capable of playing digital audio files such as .WAV or .MPG files and is conventionally known in the art. One example of such a digital audio on-hold player 104 is the INTELLITOUCH ON-HOLD PLUS 6000 DIGITAL MP3/WMA ON-HOLD MESSAG OR MUSIC AUDIO SYSTEM. Digital audio on-hold player 104 is in turn coupled with PBX or analog phone system 106. PBX or analog phone system 106 can include any such system that is conventionally known in the art and operable to communicate with digital audio on-hold player 104 to play messages from digital audio on-hold player 104.

Client 102 is communicatively coupled with a communication network, such as Internet 108. For example, client 102 may communicate over Internet 108 via HTTP/HTTPS protocol using web browsing software that is well known in the art. Further coupled to internet 108 according to the embodiment of FIG. 1 is web/application server 110. Web/application server 110 can include, for example, a computing device or server such as those available and well known in the art. Executing on web/application server 110 is user interface (UI) engine 105 according to the present invention.

Further coupled to web/application server 110 are merchant server 112 and mixing server 114. Such devices are further computing devices, for example, and operable to execute software to perform various functions, under control of the web/application server 110. For example, merchant server 112 can be a server operable to execute credit card transactions or other processing functions, such as recurring withdrawals form a financial account, such activities being well known in the art. Mixing engine 115 executes on mixing server 114 and performs the operations as described below. Further coupled to web/application server 110 is database (DB) 116. DB 116 is operable to store data—such as, in the current invention, audio files, personal customer information, payment information, and history of downloaded sessions. DB 116 can comprise any conventional database system, such as MySQL.

Although shown for the purposes of FIG. 1 as separate components, one reasonably skilled in the art will recognize that the functionality and storage of web/application server 110, merchant server 112, mixing server 114, and DB 116 may be included as a single component. That is, for example, a single computing device with sufficient storage can execute the UI engine 105, mixing engine 115, the functionality of the merchant server 112, and additionally store the data or files stored in DB 116.

In operation according to the present invention, a user desiring a personalized on-hold message operates client 102. Using, for example, a web-browser, the user communicates via client 102 over internet 108 with web/application server 110. Web/application server 110 executes UI engine 105 to present to client 102 appropriate web-pages.

Prior to access by client 102, certain audio track files have been stored in DB 116. For example, general audio track files can be created and stored in DB 116. Such general audio track files can include general messages with wide applicability to various businesses, or to various members of a certain type of business. In addition to general audio track files, certain personalized audio track files can also be stored in DB 116. For example, a personalized audio track file may include a particular business name, a user's name or a particular user's job title, among others.

UI engine 105 presents to client 102 a user interface that allows the user to create personalized on-hold message in the following manner. UI engine 105 presents to client 102 an interface that allows the user to select which general audio track files the user wishes to be in the message. UI engine 105 can present various selections to be made by the user, such as different general messages, gender of the speaker, language of the speaker, background music, and other selectable choices. UI engine 105 passes such information, for example as parameters, to mixing engine 115. In addition, for example through a log-in procedure, UI engine 105 can pass to mixing engine 115 parameters that can uniquely identify the user.

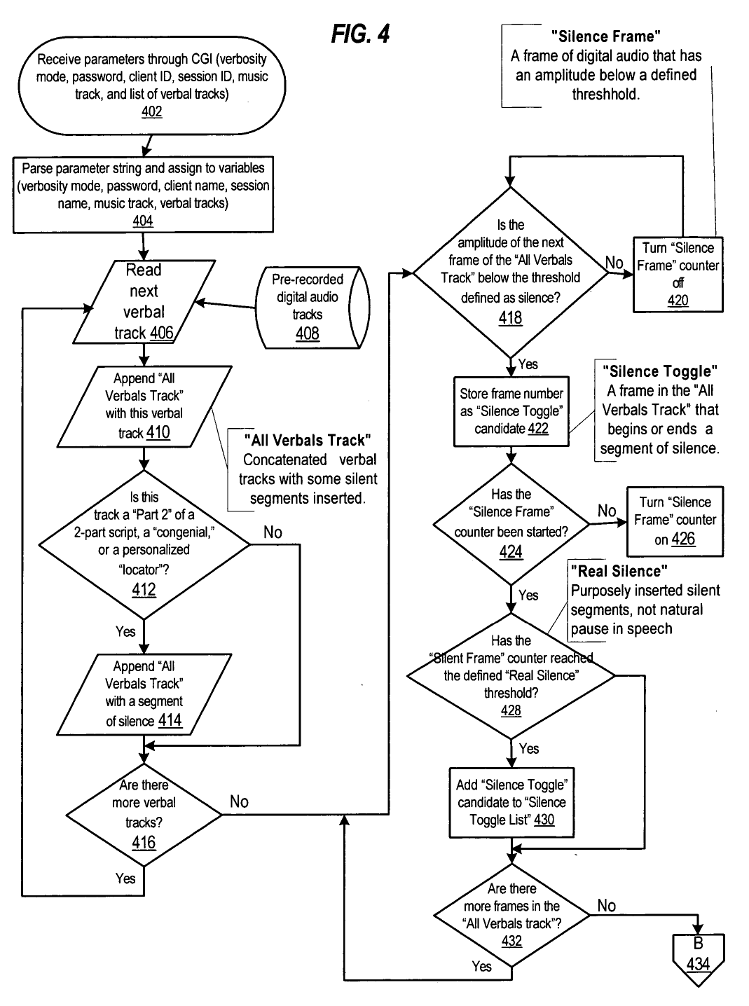

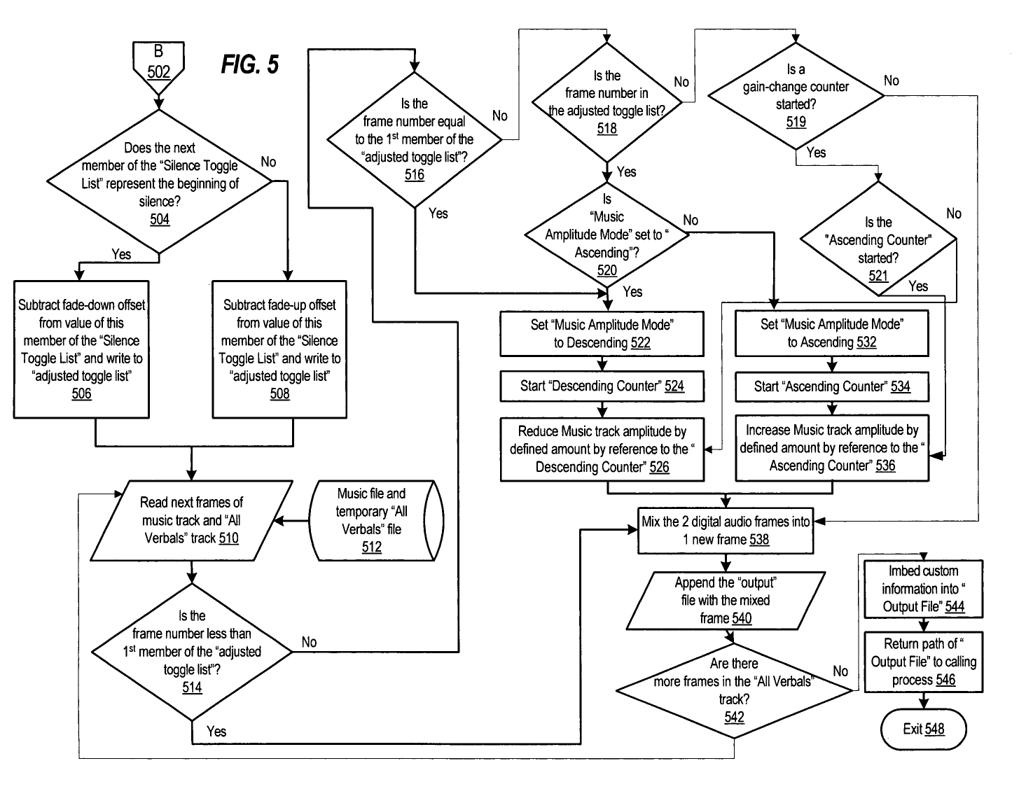

Mixing engine 115 associates, for example by use of the parameters passed through UI engine 105, the user with that user's personalized audio track message. Mixing engine 115 can then retrieve the personalized audio message associated with that user from DB 116 along with the selected general audio messages that the user selected. Mixing engine 115 then mixes the selected general audio track file(s) with the personalized audio track file into a final audio track file. In an alternate embodiment, mixing engine can further mix into the final audio track file a music background, for example by mixing in a music audio file that is also stored in DB 116. The operation of mixing engine 115 is further explained in association with the flow charts of FIGS. 4 and 5.

After the final audio file is created, mixing engine can cause the final audio file to be stored into DB 116. Additionally, the final audio file can be downloaded by client 102 over internet 108. The final audio file is then loaded into digital audio on-hold player 104, for example through a USB connection or digital media (such as memory card or smart card). Digital audio on-hold player 104 then can play the final audio file as an audible message through PBX or analog phone system 106 when, for example, an incoming call is put “on hold.” The final audio track file can be in any digital format, for example MPEG or WAV file.

In a further embodiment, merchant server 112 operates payment processing functionality, as needed, for operation of the system. For example, for the use of the system displayed in FIG. 1, the user may be charged a fee. The processing of the payment of such a fee can be executed by merchant server 112, for example by receiving credit card information passed from client 102 to UI engine 105, and then to merchant server 112.

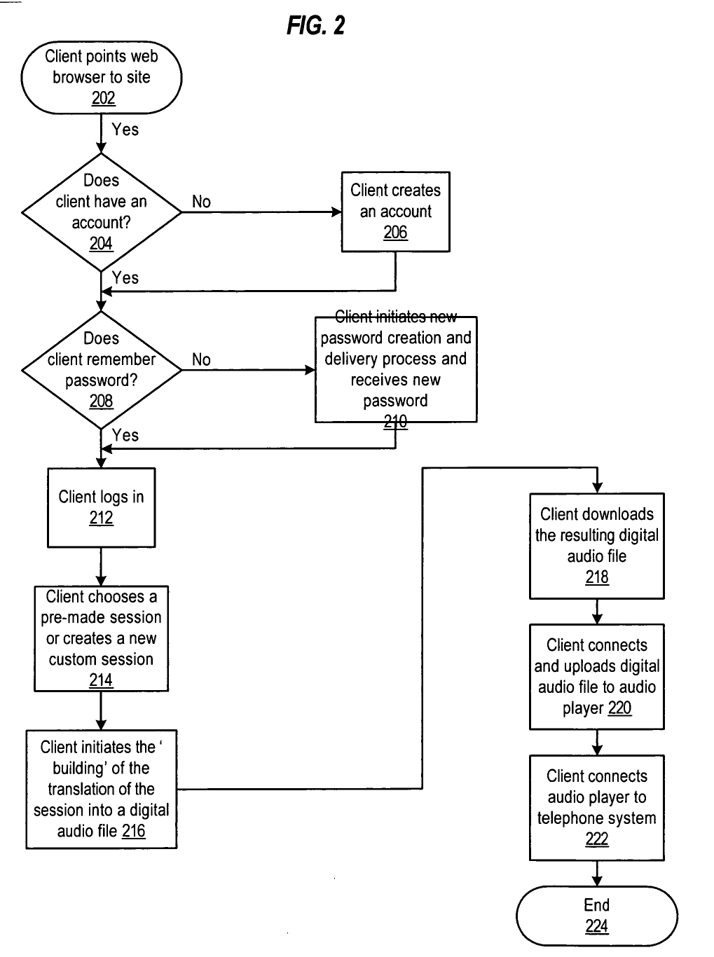

FIG. 2 is a flow chart of the operation of a dynamic mixing system according to an illustrative embodiment of the present invention. At step 202 a client (for example through the client 102 of FIG. 1) operates a web browser to access the appropriate web-site for operation of the present invention. At steps 204 and 206, it is determined if the user has an account, and if not, an account is created. At steps 208 and 210, the client either log into the user's account, or if the user has forgotten his password, receives confirmation of that password. For example, at step 210, if the user does not remember the password, such password can be delivered via electronic mail to the user.

At step 212, the client logs in to the service. At step 214, the client chooses a pre-made session or creates a custom session. As used with respect to this embodiment, “pre made session” indicates a grouping or selection of general audio tracks that has been made previously, either by the user or by an administrator. As used with respect to this embodiment “custom session” indicates the user must select the audio track files the user wishes to be mixed into the final audio track file. In one embodiment, the user at this step 214 can also select background music to be mixed into the final audio track file. At step 216, the client initiates the building of the final audio track file. The process of building the final audio track file is explained, for example, with respect to FIGS. 4 and 5.

At steps 218 through 222 the client downloads the final audio track file, uploads the file to the audio player, and connects the audio player to the telephone system.

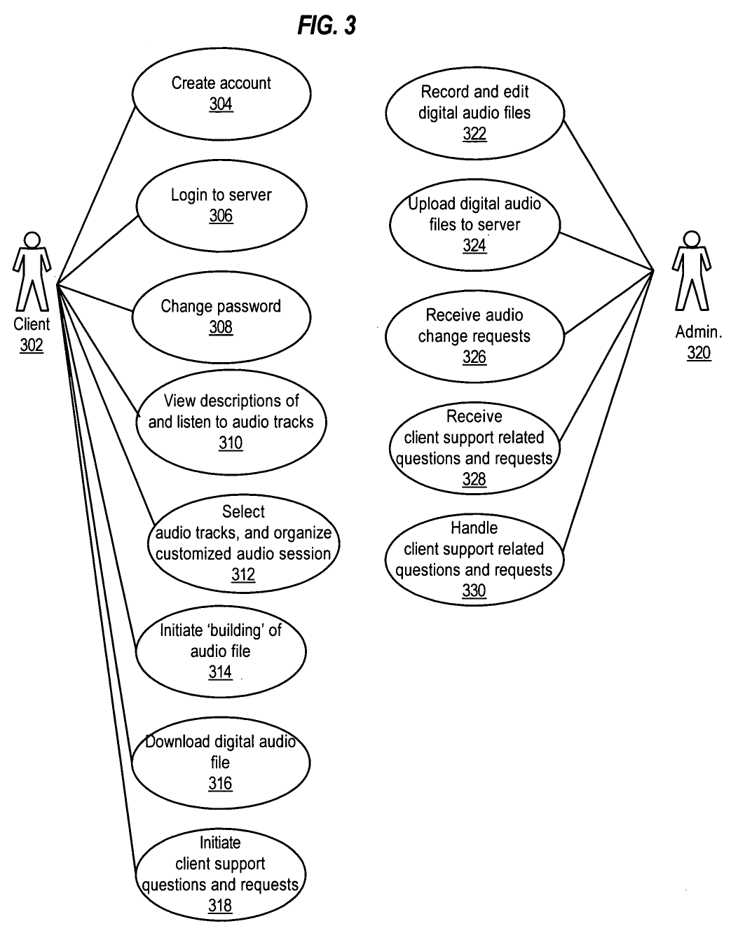

FIG. 3 illustrates a diagram of a user interaction according to an illustrative embodiment of the present invention. The figure also relates to the different actions available to different users of the system. For example, the client 302 of the system performs the actions listed by items 304-318. An administrator 320 can perform the activities listed by items 322-330. Viewing FIG. 1, the Administrator can perform such tasks, for example, through a computer also connected to web/application server 110 through internet 108.

The tasks of client 302 are described with respect to previous and following figures. The tasks that administrator 320 can perform include at step 322 the recording and editing of digital audio files (or tracks) and at step 324 uploading the digital audio files to the server. As shown on FIG. 1, such files can also be stored in DB 116. Examples of the types of files include general audio track files, personalized audio track files, and music files. General audio track files are audio tracks that have applicability across more than one user. Personalized audio track files include audio tracks personalized to a particular user, for example a track that includes a person's name. Furthermore, administrator 320 may want to create and store tracks using different languages or different speakers (such as male or female).

At step 320, an administrator may receive an audio change request. This involves receiving from clients requests to add or modify current audio files. For example, a client may desire to create an on-hold message that announces a certain discount on a product. The client may send such a request to the administrator, who may then create such an audio track. After the audio track is loaded onto the server (or database) by the administrator, such track is available when the client wishes to create a final audio track and use for an on-hold message.

At step 328 and 330, the administrator may receive and handle client support related question and requests.

FIG. 4 illustrates part 1 of 2 of a flow chart of operation of a mixing engine according to an illustrative embodiment of the present invention. For example, in reference to FIG. 1, mixing engine 115 may practice the method of FIG. 4 through software executing on mixing server 114. At step 402, the mixing engine receives parameters from the computer generated interface (CGI or UI engine 105 of FIG. 1). Examples of parameters received include verbosity mode, password, client ID, session ID, music track, and list of verbal tracks. The list of verbal tracks can include the list of general audio track files that the user has selected. The list of music tracks can include the music audio files that the user selects for background music. The password and client ID are information that can be used to uniquely identify the user. At step 404, the above parameters are parsed and assigned to variables.

At step 406 a verbal track is selected and then retrieved at step 408. For example, the pre-recorded digital audio track that is retrieved at step 408 can be the selected general audio track file or it could be a personalized audio track file. Next, at step 410 the verbal track is appended to the current “all verbals track.” The “all verbals track” includes all of the tracks that have been retrieved at this point in the method with silent segments inserted as needed. At step 412, it is determined whether or not a segment of silence needs to be added to the “all verbals track” at step 414. The determination is made at step 412 by determining whether the current track is “part 2” of a 2-part script or a personalized locator (or track). At step 416, if there are further tracks to be mixed, the method returns to step 406. Otherwise, the method proceeds to step 418.

At step 418 a determination is made as to whether the next frame of the “all verbals track” has a gain amplitude that is below a threshold defined as silence. For the purposes of the present embodiment, a frame is the unit of audio data that can independently represent a gain (or volume of audible sound). For example, for the present embodiment, a frame may represent 36 to 400 milliseconds of audio data. For further example, the threshold could be set at 2% of the maximum gain (meaning that any frame having a gain below 2% of the maximum gain would indicate that the frame is a frame of silence). If the determination made at Step 418 is true, the method proceeds to step 422, otherwise a silence frame counter is turned off at step 420 and the method returns to step 418. For the purposes of the present embodiment, the silence frame counter is a variable that counts the frames as the silence insertion loop (steps 406 through 416) is executed. At step 422, the frame number is stored as a silence toggle candidate.

The method proceeds to steps 424 and 426, where a silence frame counter is turned on if necessary and then at step 428 a determination is made if the silent frame counter matches a “real silence” threshold. The real silence threshold indicates that a moment of silence was long enough to indicate an intentional silent segment is in the track as opposed to a natural pause in speech. If the real silence threshold is met, then at step 430 the “silence toggle candidate” is added to the “silence toggle list.” For the purposes of the present embodiment, the silence toggle list is a list of frame numbers that indicates the frames of a verbal track where silence begins and ends. If the determination at step 428 is false, the step of 430 is skipped. The method then moves to step 432 where if there are more frames in the “all verbals track” the method returns to step 418, otherwise the method moves to step 434. As indicated, step 434 proceeds to FIG. 5 at the “B” indication.

FIG. 5 illustrates part 2 of 2 of a flow chart of operation of a mixing engine according to an illustrative embodiment of the present invention. This portion of the method enables the current invention to mix music files with the selected audio track. This portion of the method further enables the invention to lower the amplitude (or volume) (“fade out”) of the music during the speaking parts of the message, and then re-raise (“fade in”) the volume of the music at the end of the spoken message. The method proceeds from step 432 of FIG. 4 to step 502 on FIG. 5. At step 504, it is determined if the silence represents the beginning of a silence segment. For the purposes of the present embodiment, a silence segment is approximately eight seconds of silence. This step 504 determines if the current frame of silence is the beginning of an inserted approximately eight seconds of silence, or a smaller segment of silence that occurs naturally in speech. If determination at step 504 is true, then at step 506 a fade-down offset is subtracted from the “silence toggle list” and written to an “adjusted toggle list.” If the determination at step 504 is false, then at step 508 a fade-up offset is subtracted from the “silence toggle list” and written to an “adjusted toggle list.”

For the purposes of the present embodiment, the adjusted toggle list represents frame numbers before the frame numbers where silence occurs. This adjusted toggle list is maintained so that, through the method of the current invention, the music can mixed in to “fade in” and “fade out” surrounding moments of silence. For example, if the silence toggle list indicates moments of silence begin at frame numbers 780000 and 1060000, the adjusted toggle list may be set to 762500 and 1059500. Then, as the invention mixes in music, the music can begin to fade in at the times indicated by the adjusted toggle list. In the final audio track file, this will sound to a user that the background music begins to “fade in” slightly before the speaking portion of the message ends, such that when the speaking portion does end, the volume of the background music is set at its full amplitude.

After either step 506 or 508, at step 510 the next frame of a music track and the “all verbals” track is read. This step is accomplished by reading from step 512 the music file as well as a temporary version of the “all verbals” file. For the purposes of the present invention, the temporary “all verbals” track is a file written on the server in a reserved directory. The creation of this file occurs at step 410 (of FIG. 4). At step 514, it is determined whether the frame number is less than the first member of the “adjusted toggle list.” For the purposes of the present embodiment, the frame number indicates the number of the current frame being processed. This step 514 determines if the first silence toggle (the frame number of the beginning of a segment of silence) has been reached. As will be seen, if step 514 is true, that means that the current frame being process is before the first silence toggle, and so the verbal and music frames are mixed without gain manipulation.

If the determination at step 514 is true, the method proceeds directly to step 538. This determination indicates that the current frame is less than the first frame where amplitude adjustment of the music track needs to occur. Thus, the method proceeds directly to step 538 to mix the audio and music tracks without music amplitude (gain) adjustment.

If the determination at step 514 is false, the method proceeds to step 516. At step 516, it is determined if the frame number is equal to the first member of the adjusted toggle list. If true, the method proceeds to step 522. The “true” determination indicates the beginning of the first “fade out”—that is, the amplitude (or gain) of the background music track will be ramped down (see steps 522-526) because a segment of speaking is about to begin.

If the determination at step 516 is false, the method proceeds to step 518. At step 518, it is determined if the frame number is in the adjusted toggle list. If step 518 is true, the method proceeds to step 520. If the frame number is in the adjusted toggle list, that means that the frame is a frame where either the gain for music track (i.e., volume of music) must be ramped down (because speaking is about to begin) or that the gain for the music track must be ramped up (because speaking is about to end). Thus, if the determination at step 518 is true, the method proceeds to step 520 where it is judged if the “amplitude mode” is currently set to ascending or descending. Since the amplitude mode is set initially to “descending” (volume fade out or descending) at the first toggle (see steps 516 true branch to step 522), that means that the next toggle will indicate that the volume should fade up (ascending). Thus, at step 520, if the determination is false, the method will move to step 532 (indicating the current frame is the beginning of an ascending fade in) while if the determination at step 520 is true, that indicates that the past toggle was an ascending fade in, and thus current frame is a toggle for a descending fade in, thus the method moves to step 522.

If the determination step at 518 is false (current frame is not a number in the adjusted toggle list), then the method proceeds to step 519. At step 519, it is determined if a gain-change counter has started. If the gain change counter has started, that indicates that the current frame is part of either an ascending (fade in) gain change, or a descending (fade out) gain change. Thus, if the determination at step 519 is false (i.e., no current gain change occurring), then the method proceeds to step 538 and the two digital audio (music and speaking) frames are mixed into a new frame. If step 519 is true (i.e., the current frame is part of a gain change operation), at step 521 it is determined if there is an ascending or descending gain change operation in place by checking to see if the ascending counter is started. If the counter has started (meaning part of an ascending gain change), the method at 521 proceeds to step 536. If the ascending counter has not started at step 521 (indicating a descending gain change in progress) the method proceeds to step 526.

If determination at step 520 is “true,” that indicates that the current frame is a toggle and that the past toggle was an ascending gain change. Since the last toggle was ascending, that indicates the current toggle must be a descending toggle. Thus, the method proceeds to step 522 to set the amplitude mode to descending. A descending counter is started at step 524. The descending counter counts the time (for example by counting the frames, or other method) of a descending gain operation. The method then moves to step 526 to reduce the music track amplitude by a defined amount by reference to the descending counter. For example, the amplitude of the music track could be progressively decreased as the descending counter increases, meaning the volume of the music track will be progressively lower until a certain counter is reached (and some frame after that, the speaking begins). The present embodiment at step 526 could reduce the music track until it is inaudible, or until a certain point is reached, meaning both the speaking and music will be heard in the playback of the final audio track.

A reciprocal method of steps 522, 524 and 526 are performed by steps 532, 534, and 536 if the determination at step 520 is false. The determination of 520 being false indicates the current frame is an ascending toggle. Thus, the steps at 532, 534, and 536 must begin an ascending counter and progressively increase the music track amplitude by reference to the ascending counter until the maximum amplitude is reached.

The method proceeds from either step 526 or step 536 to step 538, wherein the two digital audio frames are mixed into a single frame. That is the frame that is part of the verbal track is mixed with the frame that is part of a music track. At step 540, the mixed file is appended to the “output” file. At step 542 it is determined if there are more frames in the “all verbals” track, and if so, the method returns to step 510. If step 540 determines there are no remaining frames in the all verbals track (indicating the output file is the final audio track file), the method proceeds to step 544 where custom information is imbedded into the output file. The custom information can include, for example, information about the user, session, or other information and can be imbedded, for example, into the ID3 tag defined by the MP3 standard.

At step 546, the output file is returned to the calling process and the method of the mixing engine ends at step 548. Output file can be formatted as any digital file, such as MPEG, MP3, or WAV file.

Those reasonably skilled in the art will understand the method of FIGS. 4 and 5 are illustrative of an embodiment of the present invention, and illustrate on possible implementation of the method as claimed by the appended claims. However, certain substitutions of steps and alternative methods are possible.

Through the method as explained by FIGS. 4 and 5, and accompanying text, one reasonably skilled in the art can see that the present invention allows a final audio track to be built by combining the selected general audio tracks (selected by a user), personalized audio tracks (that are associated with the user), and any selected music tracks (selected by the user). In addition, the invention can create the final audio track to have the music fade out when the speaking portion of the audio tracks begin, and fade in when the speaking portion of the audio track ends.

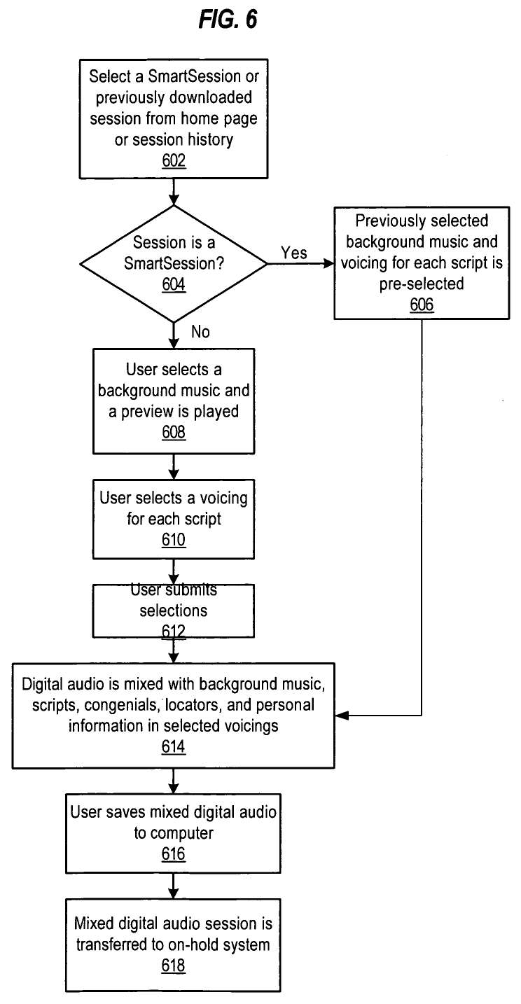

FIG. 6 is a flow chart of the operation of a dynamic mixing system according to an illustrative embodiment of the present invention. For example, the method of FIG. 6 can begin after a user “logs in” to the service and is presented with the user interface of the service on that user's web-browser. Then, at step 602, the user selects a “smart session” (which is a previously selected set of options). If the message is a “smart session”, then the method proceeds from step 604 to step 606, where the pre-selected options are loaded. The method can then proceed to step 608 to allow a user to make changes to the pre-selected options, or the method can alternatively proceed to step 614.

If the session is not a “smart session” the method proceeds from step 604 to step 608. At steps 608, 610, and 612 the user selects the scripts, voicing, and music and submits these selections. At step 614, the final audio track is created, for example by performing the method as described in relation to FIGS. 4 and 5, by mixing the selected audio and music tracks. At step 616, the final audio track is saved to the user's computer, for example by downloading the final audio track. At step 618, the final audio track is transferred to the on-hold system, for example through a USB or other network connection, or by using digital storage media. The on-hold system is connected to the PBX or analog phone system, so that the final audio track can be played over the phone system at the appropriate time, such as when a customer is placed “on hold.”

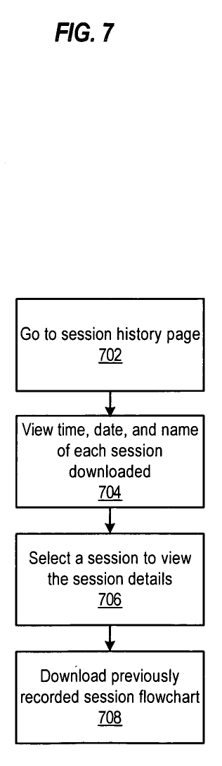

FIG. 7 is a flow chart of a session history process according to an illustrative embodiment of the present invention. The method, as described by FIG. 7, allows a user to view past sessions.

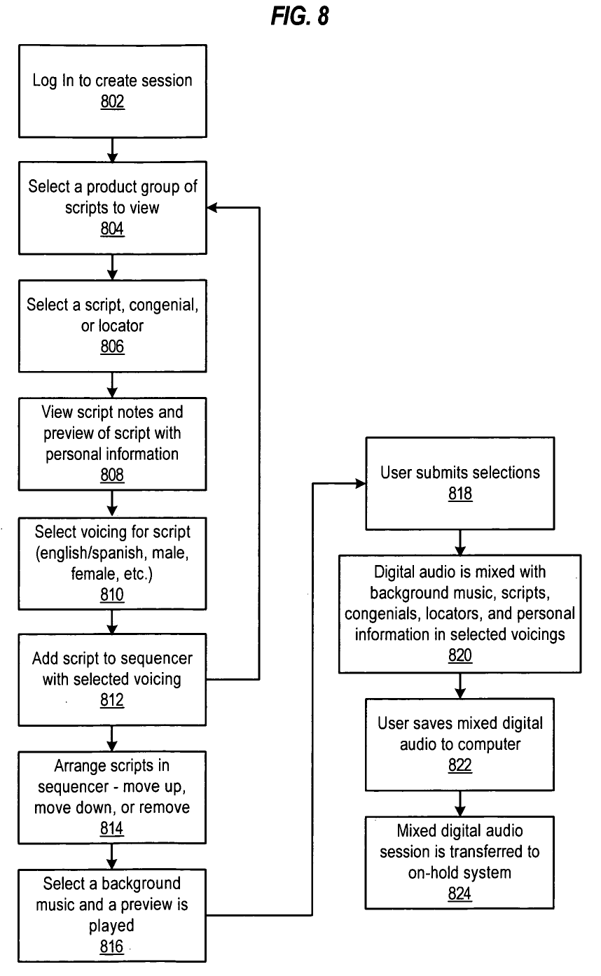

FIG. 8 is a flow chart of a custom session process according to an illustrative embodiment of the present invention. In the method of FIG. 8, a user logs onto the system to create a session at step 802. At step 804, the user selects a product group of scripts to view. The scripts represent general audio track files for the user to select in creating the user's final audio track file. For example, alternatives can be presented to user through the user interface engine. The user, at step 806 selects a script such as a congenial (a generic verbal track such as “thank you for holding, your representative will be with you”) or locator (a verbal track such as “we are located at 123 Gate Ridge Drive” or other desired script. At step 808 the user can view notes of the script or other personal information. At step 810, the user selects the voicing and language desired. At step 812, the selected script (general audio track file) is added to the “sequencer.” The sequencer keeps track of the sequence of selected scripts. The method then returns to step 804 for further selections by the user. After all the desired scripts are chose, at step 814 the user can re-arrange the scripts to the user's desired order. At step 816, a background music is selected. An alternative embodiment allows the user to select numerous different backgrounds throughout the final audio track.

At step 818, the user submits selections, and at step 820 the final audio track is created, for example by performing the method of FIGS. 4 and 5. At steps 822 and 824, the user saves the final audio track file and transfers it to the on-hold system.

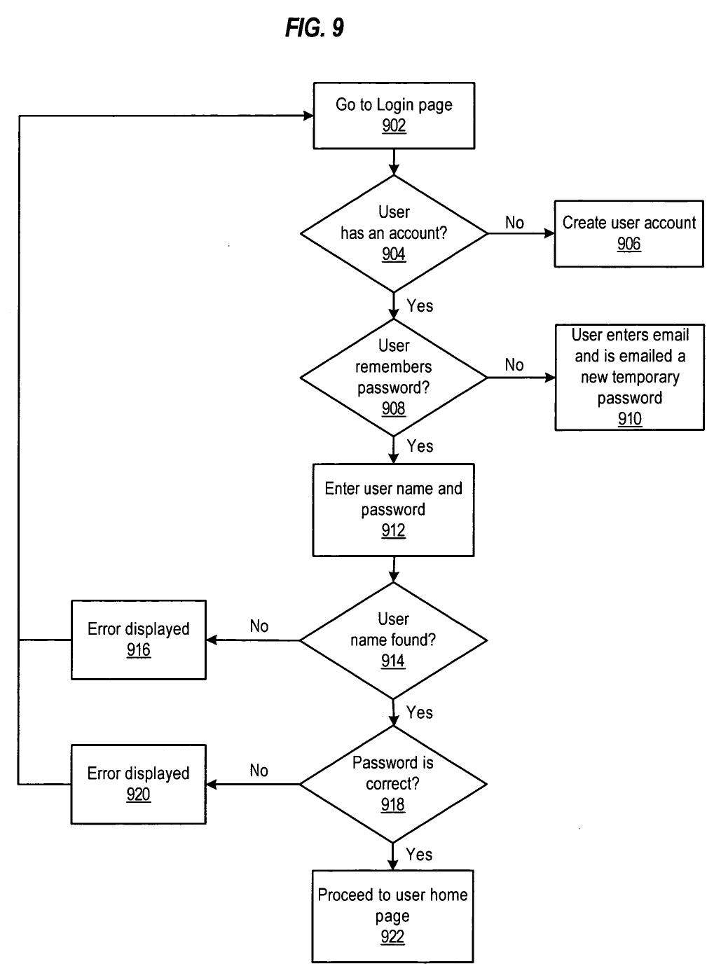

FIG. 9 is a flow chart of a login process according to an illustrative embodiment of the present invention. The method, as described in FIG. 9, allows each user to have a unique account.

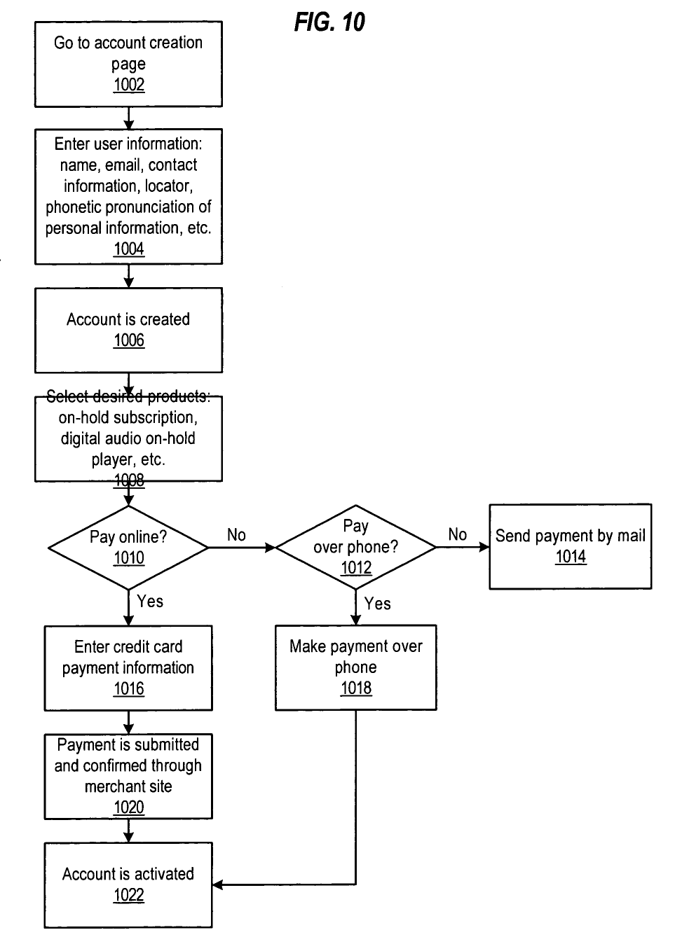

FIG. 10 is a flowchart of an account creation process according to an illustrative embodiment of the present invention. The method, as described in FIG. 10, also allows for a payment process for the user to submit payments for use of the service of the present invention.

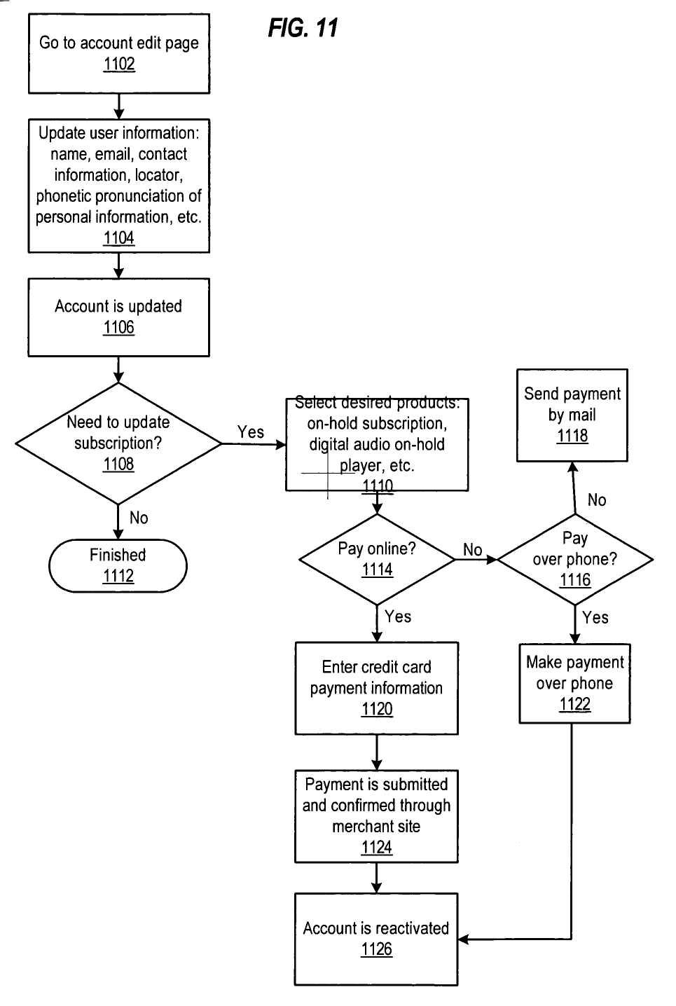

FIG. 11 is a flowchart of an account edit process according to an illustrative embodiment of the present invention. The method, as described in FIG. 11, further allows for payment by the user for use of the service of the present invention.

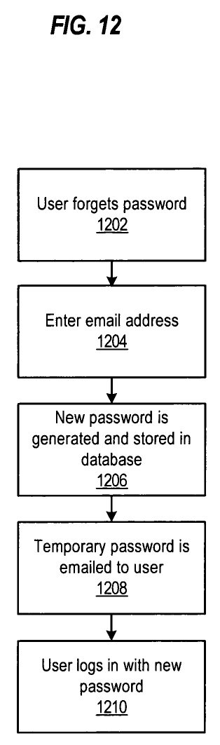

FIG. 12 is a flowchart of a forgotten password process according to an illustrative embodiment of the present invention.

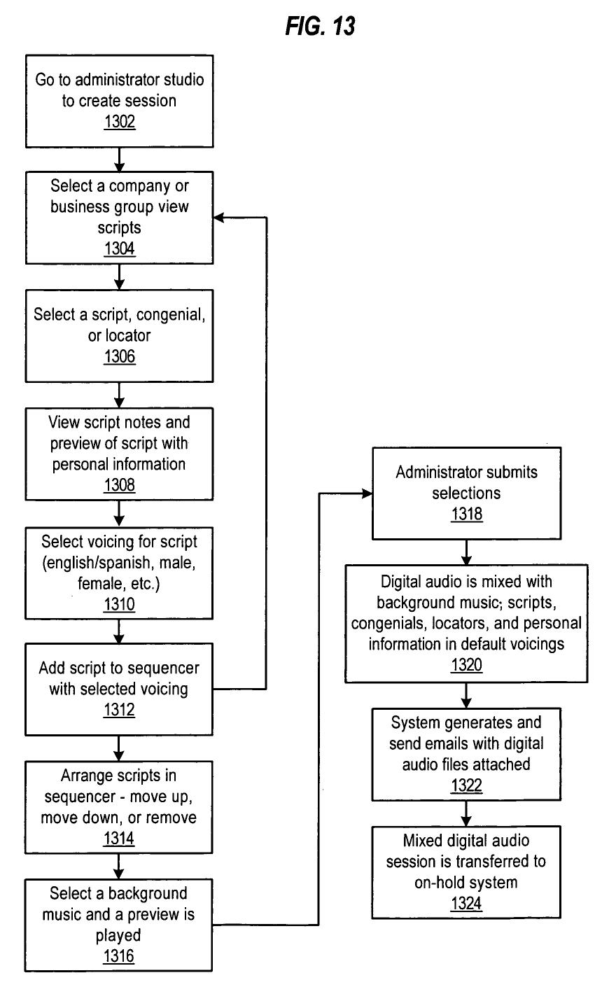

FIG. 13 is a flowchart of a process for creating and distributing a bulk message according to an illustrative embodiment of the present invention. At step 1302, an administrator logs on to the system of the present invention. At step 1304, the administrator selects a company or business group in order to view scripts available for such customers. At step 1306, a script is selected and at step 1308 notes associated with that script can be viewed. At Steps 1310, 1312, 1314, 1316, and 1318, the administrator selects the scripts, arranges the scripts, and selects a background music and submits these selections.

At step 1320, the final audio track is created by mixing the selections made in the previous steps, for example by performing the method described in FIGS. 4 and 5. During this step 1320, the present invention can, for example by associating a group of users with a the business group, create a separate script for each user. For example, by executing the method as described in FIGS. 4 and 5 for each member associated with the business group, the present invention can create a final audio track that, for each user, includes the selected general audio tracks and music tracks selected by the administrator, but also includes the personalized audio tracks that are unique to that user.

At step 1322, the final audio track for each user is e-mailed to the appropriate members of the business group. Alternatively, the final audio track can be saved to the system, and an e-mail sent to the appropriate members indicating the final audio track is available. At step 1324, after members download the final audio track, the track is transferred to the appropriate on-hold system.

The exemplary embodiment described may be implemented with a data processing system and/or network of data processing computers that provide pre-recorded audio tracks (such as voice or music) for selection, assembly and downloading over a communication network through a standard web browser. For example, data processing may be performed on computer system which may be found in many forms including, for example, mainframes, minicomputers, workstations, servers, personal computers, internet terminals, notebooks, wireless or mobile computing devices (including personal digital assistants), embedded systems and other information handling systems, which are designed to provide computing power to one or more users, either locally or remotely. A computer system includes one or more microprocessor or central processing units (CPU), mass storage memory and local RAM memory. The processor, in one embodiment, is a 32-bit or 64-bit microprocessor manufactured by Motorola, such as the 680X0 processor or microprocessor manufactured by Intel, such as the 80X86, or Pentium processor, or IBM. However, any other suitable single or multiple microprocessors or microcomputers may be utilized. Computer programs and data are generally stored as instructions and data in mass storage until loaded into main memory for execution. Main memory may be comprised of dynamic random access memory (DRAM). As will be appreciated by those skilled in the art, the CPU may be connected directly (or through an interface or bus) to a variety of peripheral and system components, such as a hard disk drive, cache memory, traditional I/O devices (such as display monitors, mouse-type input devices, floppy disk drives, speaker systems, keyboards, hard drive, CD-ROM drive, modems, printers), network interfaces, terminal devices, televisions, sound devices, voice recognition devices, electronic pen devices, and mass storage devices such as tape drives, hard disks, compact disk (“CD”) drives, digital versatile disk (“DVD”) drives, and magneto-optical drives. The peripheral devices usually communicate with the processor over one or more buses and/or bridges. Thus, persons of ordinary skill in the art will recognize that the foregoing components and devices are used as examples for the sake of conceptual clarity and that various configuration modifications are common.

The above-discussed embodiments include software that performs certain tasks. The software discussed herein may include script, batch, or other executable files. The software may be stored on a machine-readable or computer-readable storage medium, and is otherwise available to direct the operation of the computer system as described herein. In one embodiment, the software uses a local or database memory to implement the data processing and software steps so as to improve the online digital audio merge and mix operations. The local or database memory used for storing firmware or hardware modules in accordance with an embodiment of the invention may also include a semiconductor-based memory, which may be permanently, removably or remotely coupled to a microprocessor system. Other new and various types of computer-readable storage media may be used to store the modules discussed herein. Additionally, those skilled in the art will recognize that the separation of functionality into modules is for illustrative purposes. Alternative embodiments may merge the functionality of multiple software modules into a single module or may impose an alternate decomposition of functionality of modules. For example, a software module for calling sub-modules may be decomposed so that each sub-module performs its function and passes control directly to another sub-module.

The computer-based communications system described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries including the following: computer hardware and software manufacturing and sales, professional services, financial services, automotive sales and manufacturing, telecommunications sales and manufacturing, medical and pharmaceutical sales and manufacturing, movie theatres, insurance providers, computer and technical support services, construction industries, and the like.

Although the present invention has been described in detail, it should be understood that various changes, substitutions, and alterations can be made hereto without departing from the spirit and scope of the invention as defined by the appended claims.

What is claimed is:

1. A method for dynamically mixing audio data, comprising:
maintaining at least one general audio track file;
maintaining at least one personalized audio track file;
providing an interface to a user for allowing the user to select a selected general audio track file;
associating the personalized audio track file with the user;
retrieving the selected general audio track file and the personalized audio track file; and
mixing the selected general audio track file and the personalized audio track file into a final audio track file.

2. The method of claim 1, further comprising making the final audio track file available to be downloaded by the user.

3. The method of claim 1, further wherein the step of providing an interface comprises providing a web-based interface operable to be accessed by the user via a web-browser over the internet.

4. The method of claim 1, further wherein the steps of maintaining at least one general audio track file and maintaining at least one personalized audio track file comprise storing the general audio track file and the personalized audio track file in a database.

5. The method of claim 1, further wherein the final audio track file is in MPEG format.

6. The method of claim 1, further wherein the final audio track file is in WAV format.

7. The method of claim 1, further comprising:
maintaining at least one music audio file;
receiving from the user an indication of a selected music audio file; and
wherein the step of mixing comprises mixing the selected music audio file with the selected audio track file and the personalized audio track file into a final audio track file.

8. A system for dynamically mixing audio data, comprising:
a storage interface to a digital storage, the digital storage for maintaining at least one general audio track file and at least one personalized audio track file;
a user interface engine for providing an interface to a user that allows the user to select a selected general audio track file; and
a mixing engine for associating the personalized audio track file with the user, retrieving the selecting general audio track file and the personalized audio track file; and mixing the selected general audio track file and the personalized audio track file into a final audio track file.

9. The system of claim 7, further wherein:
the user interface provides a web-based interface operable to be accessed by the user via a web-browser over the internet.

10. The system of claim 7, further wherein the digital storage comprises a database.

11. The system of claim 7, further wherein the final audio track file is in MPEG format.

12. The system of claim 7, further wherein the final audio track file is in WAV format.
